(19) United States
(12) Patent Application Publication
(10) Pub. No.: US 2009/0272051 A1
(43) Pub. Date: Nov. 5, 2009

(54) Prefabricated temporary building system consisting of interchangeable panels and a plurality of connectors used to construct walls, roofs, and floors without the need of fasteners, or tools or heavy construction equipment

(76) Inventor: Weldon Saylor Sipe, Mocksville, NC (US)

Correspondence Address: Weldon Saylor Sipe, 193 Charleston Ridge Drive, Mocksville, NC, 27028, US

(21) Appl. No.: 12/453,165

(22) Filed: Apr. 29, 2009

Related U.S. Application Data
(60) Provisional application No. 61/050,344, filed on May 5, 2008.

(51) Int. Cl. E06B 1/12; E04B 2/30; E04B 2/58

(52) U.S. Cl. 52/210; 52/483.1; 52/636

(57) ABSTRACT

The present invention relates to a system for constructing temporary prefabricated structures for the motion picture, television and stage play industries. The invention uses interchangeable panels with an array of connecting elements for constructing walls, roofs and floors. Because of this nature of interchangeability, flexibility in the use of our panels affords last minute changes in set design to accommodate desirable camera or actor movements. The materials used are substantially strong enough to withstand transportation, use in adverse weather conditions, and storage for reuse, and are recyclable when life expectancy is reached. The system does not require site preparation prior to assembling structures. Buildings can be erected on virtually any surface and over existing vegetation with out destruction. More particularly, the components used to erect the structure are easy to assemble and disassemble and do not require the use of any fasteners or tools or heavy construction equipment.

### CROSS-REFERENCE TO RELATED APPLICATIONS

Provisional Application No. U.S. 61/050,344

Filing Date: May 5, 2008

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Traditionally, the building of sets by the movie and stage industries consists mainly of using flats (stretched canvas over wood frames), or solid flats (usually thin plywood over wood frames) as support for fascia to simulate various architectural structures.

In order to use traditional flats and other materials to build walls, roofs, and floors to simulate exterior buildings, streets, or whole towns, the site must be prepared. Land must be leveled for the building of structures and cleared of vegetation for the maneuverability of construction equipment.

All set construction (including the making of flats) is done on the site. The construction process is labor intense and destructive to the existing vegetation. New grass, bushes, trees and etc. (greens) must be replaced following construction.

The materials used are chosen on the basis of economy not permanence. Construction is exempt from all building codes so appearance is the only importance, therefore construction is meant for a one-time use, and sets are not built to withstand transporting and storage for future use. Without reinforcement, used movie sets deteriorate rapidly (within a few weeks) and cannot withstand adverse weather conditions such as rain or wind. Should filming of a set be postponed due to adverse weather conditions or scheduling, damage or deterioration can be expected.

Generally, recycling is not a consideration.

### BRIEF SUMMARY OF THE INVENTION

The present invention relates to a system for constructing temporary prefabricated structures that may be erected out of doors (on location) or interior on a studio stage. The materials used consist mostly of steel components and are substantially strong enough to withstand: transportation, use in adverse weather conditions, and storage for future use.

More particularly, the use of this present system does not require site preparation prior to assembling structures. Buildings can be erected on virtually any surface and over existing vegetation with out destruction.

More particularly, the components used to erect the structure are easy to assemble and disassemble and do not require the use of any fasteners or tools or heavy construction equipment. The reduction of construction time monumentally impacts site labor.

More specifically, the invention uses interchangeable panels with an array of connecting elements for constructing walls, roofs and floors. Because of this nature of interchangeability, a flexibility is inherent in the use of our panels affording last minute changes in set design to accommodate desirable camera or actor movements.

Most specifically, the invention relates to prefabricated structures that may be dismantled after having served their purpose, readily stacked for transport, stored and reused on future sets for reasons of availability and economy.

All structures and components are completely recyclable when life expectancy is reached.

### BRIEF DESCRIPTION OF THE SEVERAL VIEWS OF THE DRAWING

FIG. 1—Isometric view of a basic panel.
FIG. 1-a—Detail of upper left corner of panel in FIG. 1.

FIG. 2—Isometric view from inside of right corner assembly.
FIG. 2-a—Detail of latching bar and lock in FIG. 2.
FIG. 2-b—Detail of lock assembly and straight slip track in FIG. 2.

FIG. 3—Isometric view from outside of right corner assembly with cross-section through sheathing.
FIG. 3-a—Detail of sheathing section and sheathing channel in FIG. 3.

FIG. 4—Isometric view of inside of window panel with sheathing.
FIG. 4-a—Detail of upper right corner of window panel showing gusset in FIG. 4.
FIG. 4-b—Isometric view of outside of window panel.

FIG. 5—Isometric view of right corner wall and roof assembly.
FIG. 5-a—Detail of receiving socket, extension assembly, extension bar and roof arch in FIG. 5.
FIG. 5-b—Detail of receiving socket, extension assembly, extension bar and ridge connecting bar in FIG. 5.

FIG. 6—Isometric view of floor assembly from below.
FIG. 6-a—Detail of receiving socket and extension assembly in FIG. 6.
FIG. 6-b—Detail of leveling jack and center jack in FIG. 6.
FIG. 6-c—Detail of span jack in FIG. 6.
FIG. 6-d—Detail of span jack in FIG. 6-c.
FIG. 6-e—Detail of screw jack in FIG. 6.

FIG. 7—Isometric view of floor assembly from above.
FIG. 7-a—Detail of floor clip, sheathing channel, leveling jack, latching bar and lock in view 7.

FIG. 8—Isometric view of inner gable panel from inside.

FIG. 9—Isometric view of outer gable panel from outside.

FIG. 10—Isometric view of panel greater than 8 feet.
FIG. 10-a—Detail of sheathing support bracket in view 10.

FIG. 11—Isometric view of interior wall intersection.
FIG. 11-a—Detail of T-slip track in FIG. 11.

FIG. 12—Isometric view of gable panel assembly.
FIG. 12-a—Detail of panel locking feature in view 12.

FIG. 13—Assembled building.
FIG. 13-a—Detail of wall to floor latching assembly in FIG. 13.

FIG. 14—Isometric view of screw jack.

FIG. 15—Isometric view of span jack.

FIG. 16—Isometric view of corner jack.

FIG. 17—Isometric view of center jack.

### DETAILED DESCRIPTION OF THE INVENTION

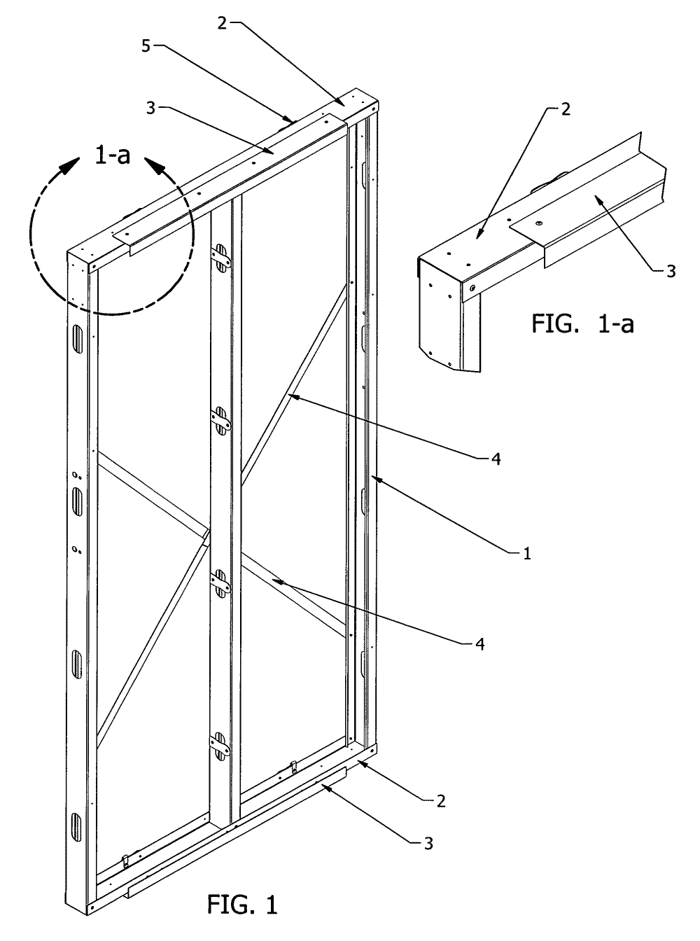

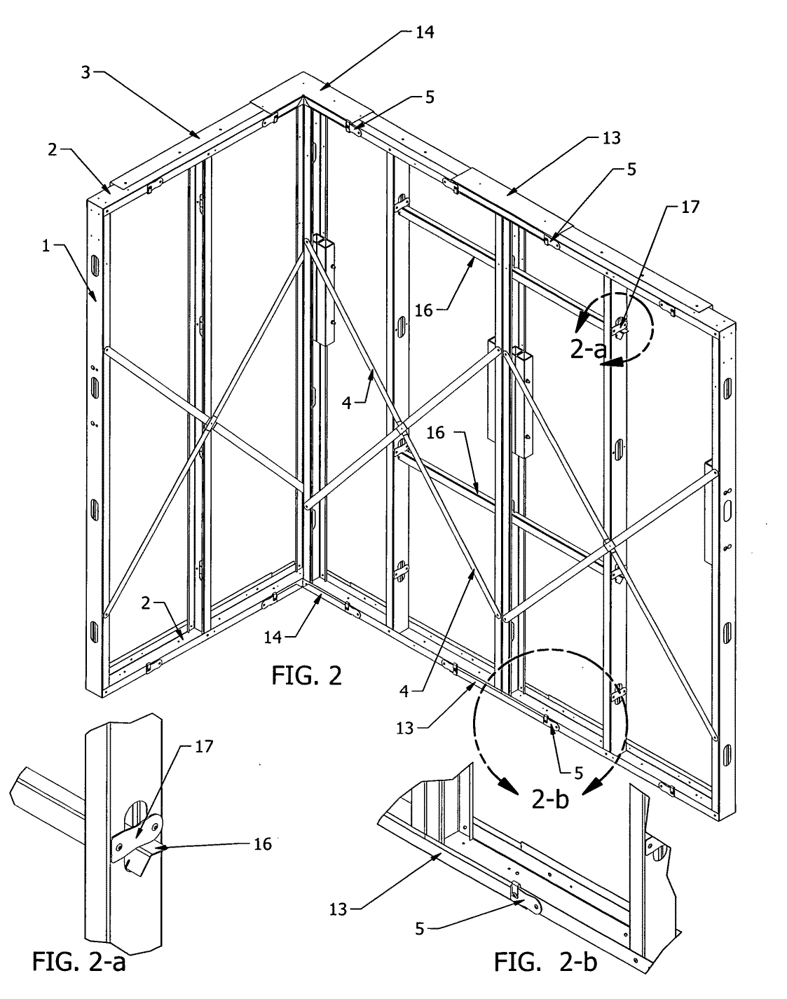

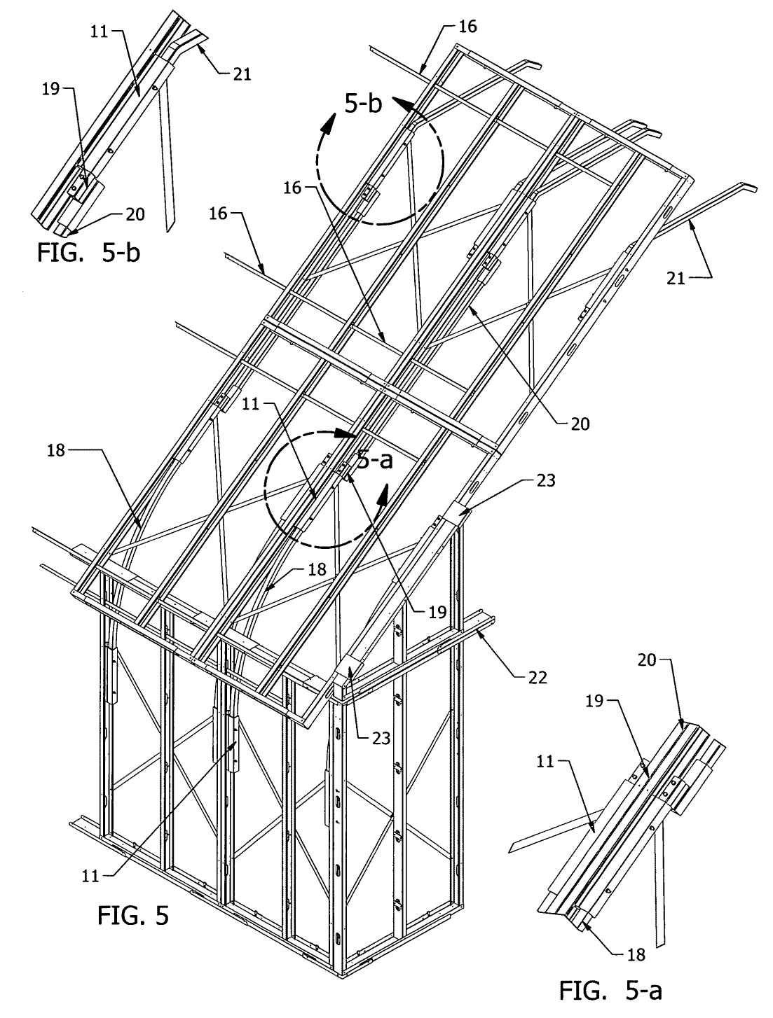

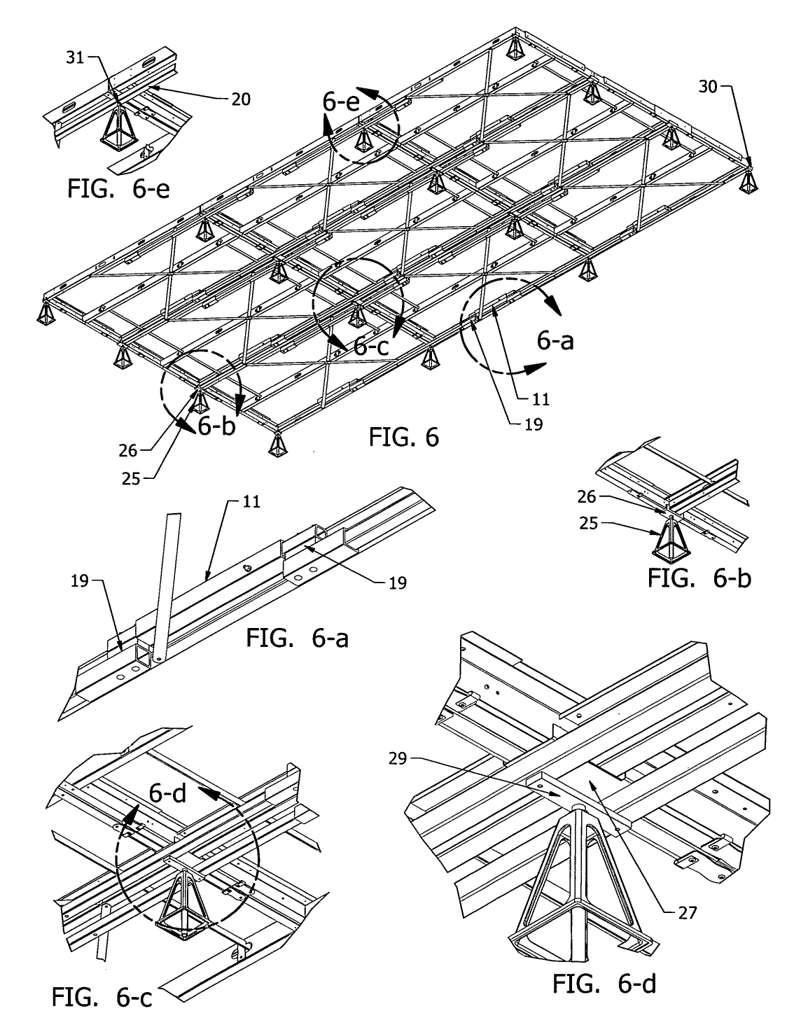

The basic PREFABRICATED PANEL is used for construction of walls, roofs and floors and consists of:
Standard STEEL STUDS 1 and TRACK 2 are riveted together to form a custom size prefabricated frame (FIG. 1).
A fabricated SHEATHING CHANNEL 3 is riveted to the top and bottom of the frame to support eventual covering of the frame with sheathing on one side (FIG. 2).
CROSS-STRAPS 4 are riveted to the other side of the frame to prevent racking (FIG. 1).
LOCK ASSEMBLIES 5 are also riveted to this side of the frame as shown (FIG. 2) to eventually secure additional parts used when constructing walls, floors and roofs.
LOCKS 17 are riveted to the center stud to secure latching bars 16 when used.
RECEIVING SOCKETS 11 are attached to the frame so that, with the additional use of other parts, roof or floor panels may be attached to one another to form a roof or floor (FIGS. 5, 6 & 7).

### Right Corner and Left Corner Prefabricated Panels

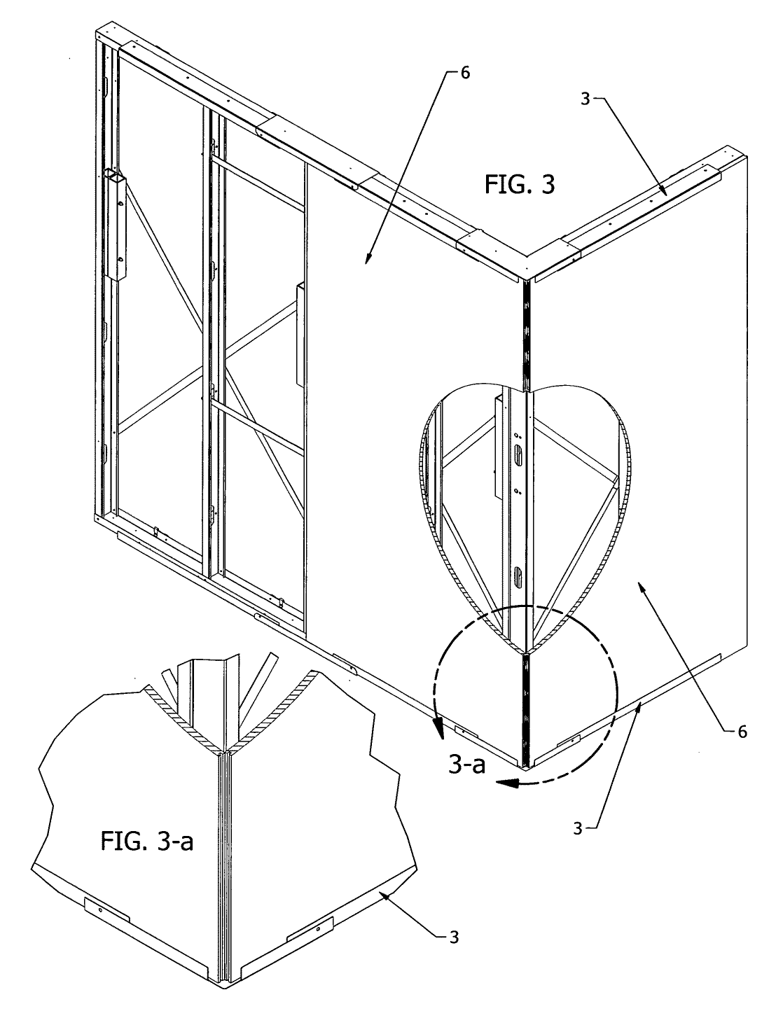

RIGHT CORNER PANELS are constructed in the same fashion as the basic panel but are shorter in width (on the right side corner edge) so that the Sheathing 6, when applied, will cover the right corner and meet with sheathing of the adjacent corner panel (FIG. 3).
LEFT CORNER PANELS are mirror image of Right Corner Panels.

### Door and Window Prefabricated Panels

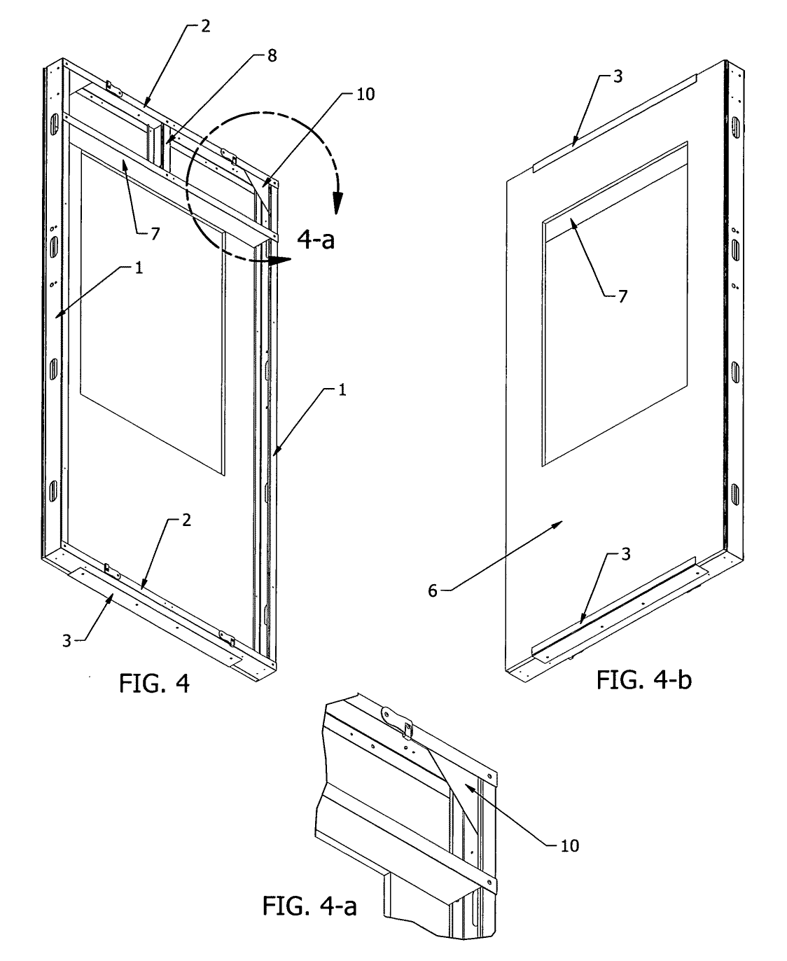

DOOR and WINDOW PANELS are identical. They consist of standard steel studs 1, track 2, sheathing channel 3, header stud 7 and cripple stud 8 that are riveted together to form a custom-size prefabricated frame (FIG. 4).
GUSSET PLATES 10 are added by riveting them to the frame to prevent the frame from racking (FIG. 4).

### Prefabricated Gable Panels

GABLE PANELS consist of standard steel studs 1, track 2, Sheathing Channel 3, Cross Straps 4, Lock Assemblies 5 and Locks 17 that are riveted together to form custom-size prefabricated frames that accommodate a specified roof pitch (FIGS. 8 & 9).
RIGHT AND LEFT-END GABLE PANELS are constructed in the same fashion as the basic gable panel but are shorter in width on the corner edges so that the sheathing, when applied, avoids having to fit snugly into the point of the roof pitch (FIG. 9).

### Prefabricated Panels Exceeding 8′ Heights.

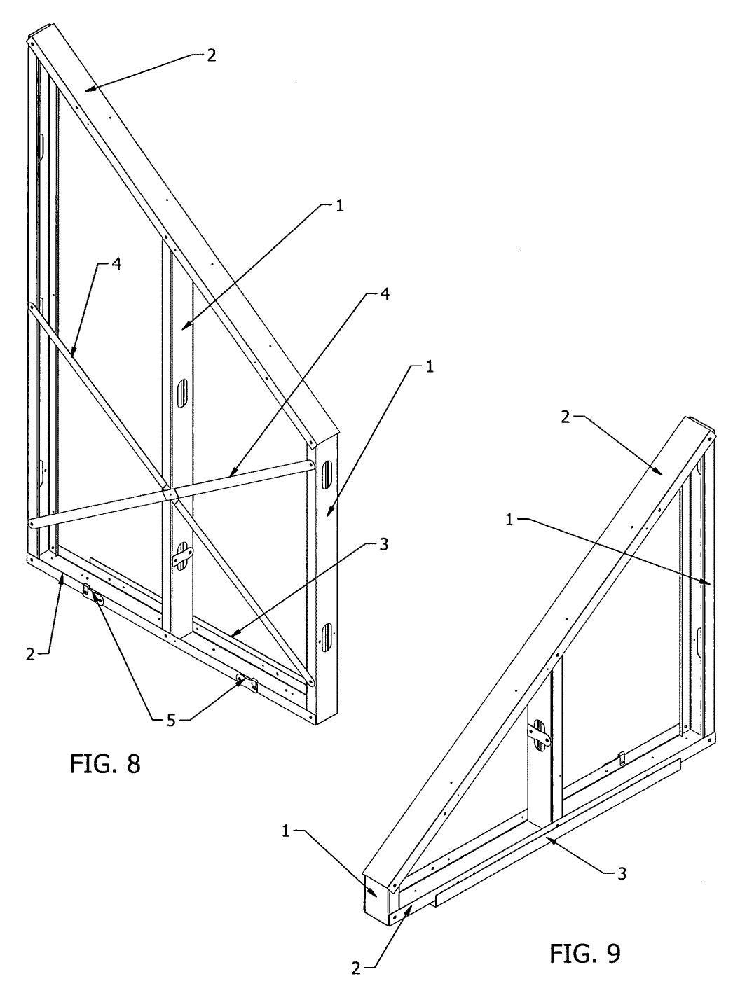

Panels (including Right and Left Corner Panels, Door and Window Panels, and Floor and Roof Panels) that are taller than 8′ must have a SHEATHING SUPPORT BRACKET 12 added to attach and support additional sheathing as necessary (FIG. 10).

### Use of Prefabricated Panels for Walls.

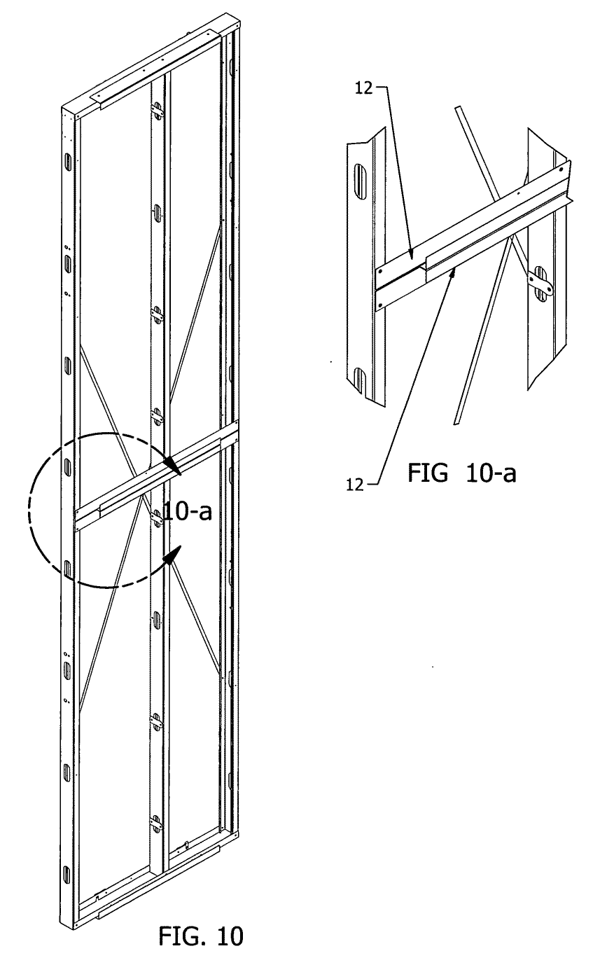

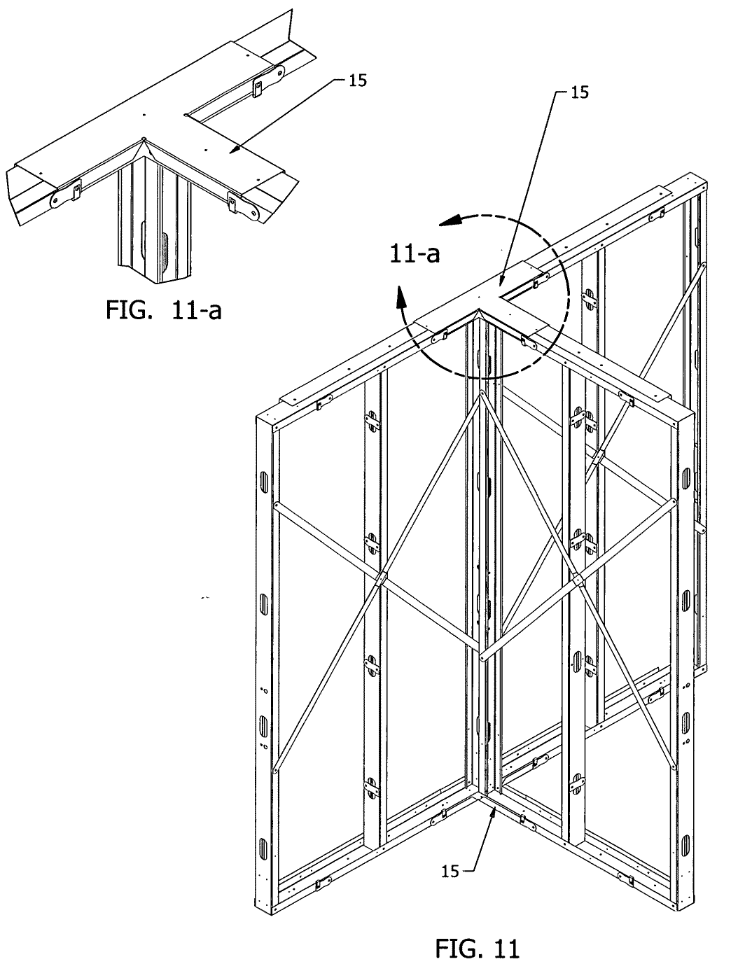

Basic Prefabricated Panels may be placed one to another to form a desired shape using our manufactured CORNER SLIP TRACKS 14 (FIG. 2), STRAIGHT SLIP TRACKS 13 (FIG. 2), and T-SLIP TRACKS 15 (FIG. 11) as necessary. They are secured by the LOCK ASSEMBLIES 5 on the frame (FIG. 2).
Then the wall panels are structurally connected using our manufactured LATCHING BARS 16 (FIG. 2) secured by the LOCKS 17 on the frame (FIG. 2).
Next ¾-INCH TONGUE AND GROOVE OSB (Sheathing) 6 is mounted to the metal frame by sliding the sheets into the Sheathing Channel 3 (or Sheathing Support Bracket 12 when used) of the frame (FIG. 3).

### Use of Prefabricated Panels for Roofs

Basic PREFABRICATED ROOF PANEL is attached to the Wall panel by connecting the Receiving Socket 11 of the Wall Panel to the Receiving Socket 11 of the Roof Panel using an EVE ARCH 18 (FIG. 5)
Additional Roof Panels may be added (end to end) to form the desired roof length by connecting the Receiving Sockets 11 of one panel to the Receiving Sockets 11 of another panel using EXTENSION ASSEMBLIES 19 (FIG. 5) and EXTENSION BARS 20 (FIG. 5) as necessary.
Roof Panels are connected at the ridge using RIDGE CONNECTING BARS 21 (FIG. 5).
Roof Panels are structurally connected (side to side) using our manufactured LATCHING BARS 16 (FIG. 5) secured by the LOCKS 17 on the frame (FIG. 2).

### Use of Prefabricated Gable Panels

GABLE PANELS are assembled and structurally connected (side to side) with the use of LATCHING BARS 16 (FIG. 12).
Gable Panels are attached to the vertical Wall Panels using DOUBLE STRAIGHT SLIP TRACKS 22 (FIG. 5).
Gable Panels are attached to the Roof Panels with GABLE SHEATHING CHANNELS 23 (FIG. 5).

### Use of Prefabricated Panels for Floors

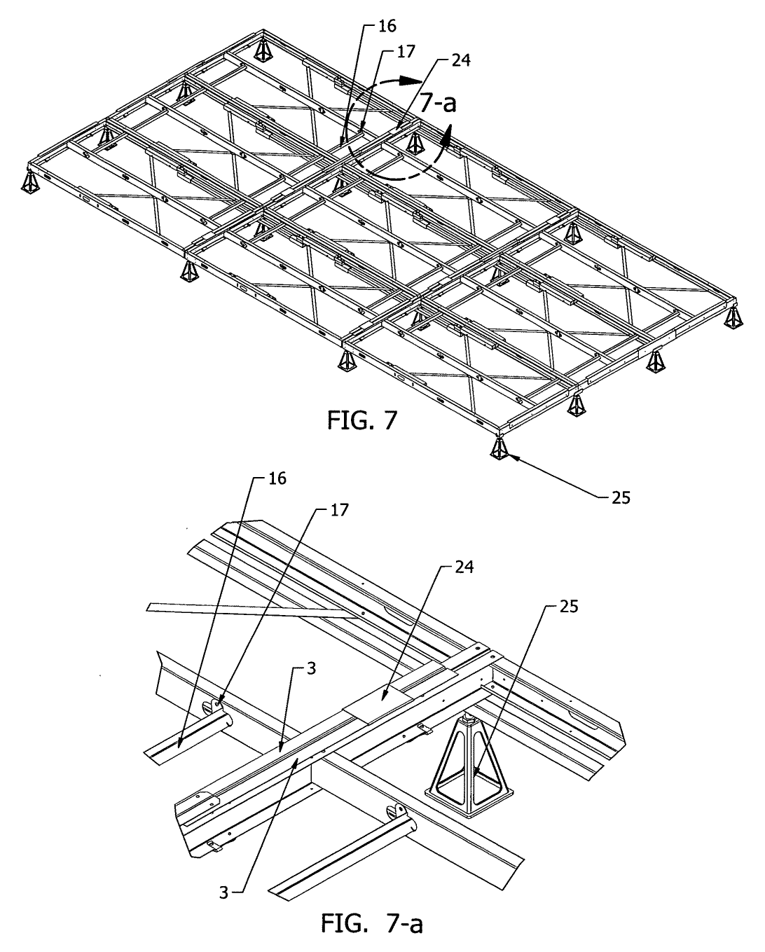

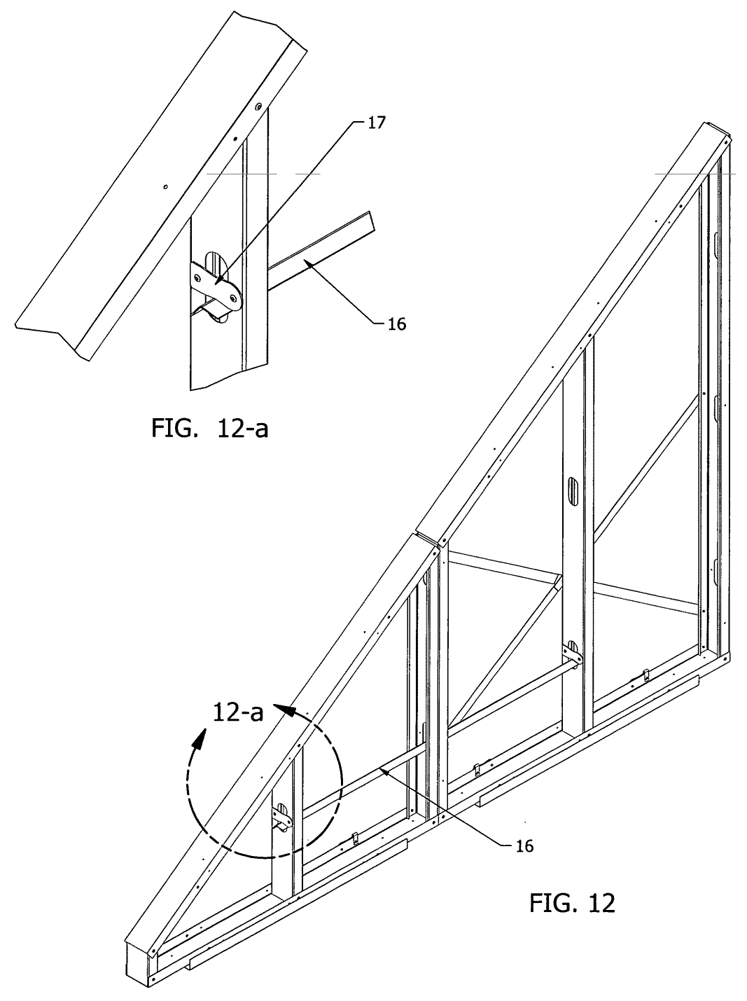

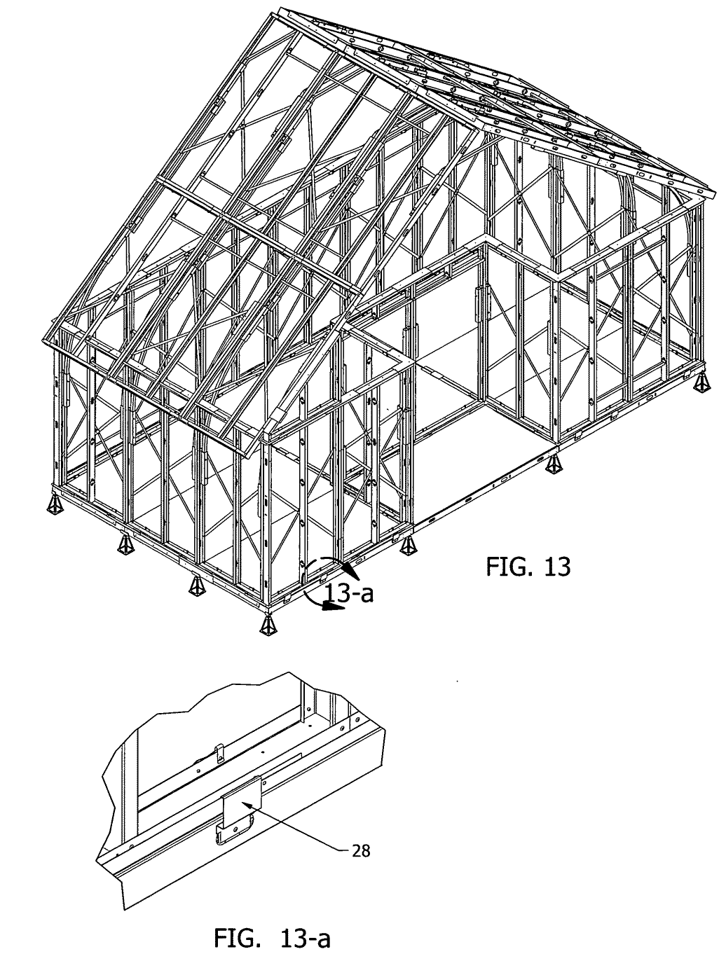

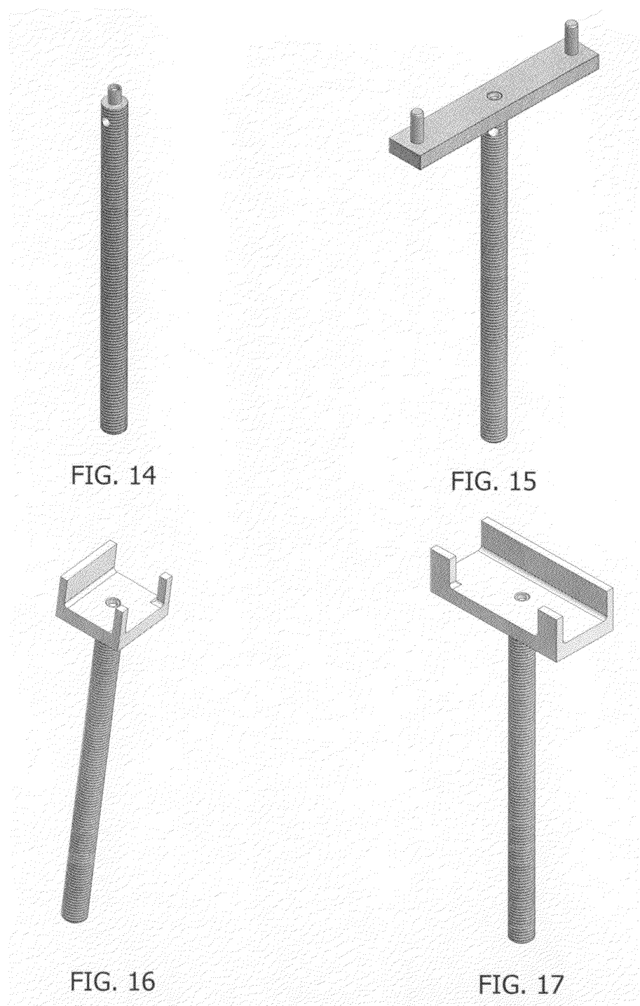

Prefabricated Panels used for FLOORS are identical to Roof Panels. They are assembled in the same fashion as roof panels except there are no Eve Arches 18 or Ridge Connecting Bars 21 needed. Floor Panels may be added (end to end) to form the desired floor length by connecting the Receiving Sockets 11 of one panel to the Receiving Sockets 11 of the next panel using EXTENSION ASSEMBLIES 19 (FIG. 6) and EXTENSION BARS 20 (FIG. 6) as necessary.
FLOOR CLIPS 24 (FIG. 7) are used to attach the Sheathing Channels 3 of adjacent panels to prevent the Floor Panels from slipping apart.
Floor Panels may be added (side to side) to form the desired floor width by using LATCHING BARS 16 (FIG. 7) and LOCKS 17 (FIG. 7) as necessary.
As the floor is being constructed, panels may be leveled using four types of LEVELING JACKS 25 (FIGS. 6 & 7) for proper balance and rigidity. The only difference between the types of Leveling Jacks is the tip of the screw, which determines where it is used on the floor frame.
Most used are SCREW JACKS 31 (FIG. 6-e & 14). The tips of the screws fit directly into pre-drilled holes in Expansion Bars 20 (FIG. 6-e).
SPAN JACKS 29 (FIGS. 6 & 15) may be used where Extension Bars of adjacent panels are close enough to allow a single jack to support both panels.
The perimeter corner of a floor uses a CORNER JACK 30 (FIGS. 6 & 16).
CENTER JACKS 26 (FIG. 6-b & 17) are used along the perimeter edge of a floor where two frames meet.
FLOOR CRADLES 27 (FIG. 6-c & d) are used to connect four panels where they meet at their corners and keep the panels from separating.
Once walls are constructed atop the floor, they are attached to the floor with WALL TO FLOOR LATCHING ASSEMBLIES 28 (FIG. 13-a).

I claim:

1. a prefabricated panel consisting of
a. standard steel studs and track that are riveted together to form a custom sized frame
b. cross straps riveted to the frame to prevent racking
c. fabricated sheathing channel riveted to the top and bottom track of the frame to support standard tongue-and-groove OSB covering of the frame
d. sheathing support brackets riveted to the studs of panels exceeding 8-feet in height to support additional sheathing as necessary
e. receiving sockets attached to the outside studs of each wall panel to accommodate various connectors
f. lock assemblies to secure various connectors
g. locks to secure other connectors.

2. further that the panel of claim 1 may be attached to additional panels (side-to-side) to form various wall configurations by using components comprised of:
a. straight slip tracks for configuring straight walls
b. corner slip tracks for configuring wall corners
c. t-slip tracks for configuring dividing walls
d. latching bars to structurally connect the wall panel to wall panel (via the stud conduit punch-outs) to keep them in place

3. further that the panel of claim 1 may be attached to additional panels to form various roof configurations with components comprising:
a. a means for attaching panels end-to-end for various slope lengths using
1. eve arches to connect the receiving sockets of the supporting wall panel and the first roof panel thereby creating an overhang
2. extension assemblies connected to the receiving sockets to provide clearance of the panel frames and accommodate
3. extension bars that connect receiving sockets of roof panels placed end to end
4. ridge connecting bars used to connect the receiving sockets of the top roof panels at the ridge
b. a means for attaching roof panels side-to-side for various roof widths using
1. latching bars to structurally connect roof panel to roof panel (side to side) via the stud conduit punch-outs

4. further that the panel of claim 1 may be attached to additional panels to form a desired size floor configuration with components comprising:
a. with means of attaching the panels from end to end to make various floor lengths comprising of
1. extension assemblies connected to the receiving sockets of the frames to provide a necessary clearance to the panel frames accommodation of
2. extension bars that connect the extension assemblies of floor panels placed end to end
3. floor clips to attach the sheathing channels of adjacent panels to prevent end-to-end panels from slipping apart
b. with means of attaching the floor panels from side to side to make various floor width comprising of
1. latching bars to structurally connect the floor panel to floor panel via the stud conduit punch-outs
c. with means for leveling the floor panels for balance and rigidity comprising of
1. screw jacks that fit directly into pre-drilled holes of expansion bars
2. span jacks that are used where extension bars of adjacent panels are close enough to allow a single jack to support both panels
3. corner jacks for all corners of the configured floor
4. center jacks that are used along the perimeter edge of a floor configuration where two panels meet
d. with means of connecting and preventing separation of floor panels where four panels meet at the corners consisting of
1. floor cradles
e. with means of attaching the floor to walls consisting of
1. wall to floor latching assemblies.

5. a prefabricated door or window panel consisting of
a. standard steel studs and track that are riveted together to form a custom-size frame
b. sheathing channel riveted to the top and bottom track of the frame to support standard tongue-and-groove OSB covering of the frame
c. a header stud riveted to the studs of the frame for structural support
d. a cripple stud riveted to the header stud and top track
e. gusset plates riveted to the studs and top track of the frame to prevent racking
f. with means for attaching other panels to make various wall configurations comprising of
1. straight slip tracks for configuring straight walls
2. corner slip tracks for configuring wall corners
3. t-slip tracks for configuring dividing walls
5. lock assemblies to secure the panels to their corresponding slip tracks
5. latching bars to structurally connect the wall panel to wall panel (via the stud conduit punch-outs) to keep them in place
6. locks to secure latching bars to the studs and keep them from becoming disengaged

6. Prefabricated gable panels consisting of:
a. standard steel studs and track that are riveted together to form a custom-sized frame with the top track and vertical studs cut to accommodate a specified roof pitch
b. sheathing channel riveted to the top and bottom track of the frame to support standard tongue-and-groove OSB covering of the frame
c. with means for attaching gable panels side-to-side to make various gable lengths comprising of
1. latching bars to structurally connect the gable panel to gable panels via the stud conduit punch-outs
2. locks to secure latching bars to the studs and keep them from becoming disengaged
c. with means for attaching the gable panels to the wall panels consisting of
1. double straight slip tracks to hold the gable panel in place
2. lock assemblies to secure the adjacent gable and wall panels to their corresponding double slip tracks
d. with means for attaching the gable panels to the roofs panels consisting of
1. gable slip tracks
